(19) United States
(12) Patent Application Publication
(10) Pub. No.: US 2004/0135919 A1
(43) Pub. Date: Jul. 15, 2004

(54) Camera module and method of fabricating the same

(76) Inventors: Na-Young Kim, Seoul (KR); Ho-Kyoum Kim, Suwon-si (KR); Young-Jun Kim, Seongnam-si (KR)

Correspondence Address: GOTTLIEB RACKMAN & REISMAN PC, 270 MADISON AVENUE, 8TH FLOOR, NEW YORK, NY, 100160601

(21) Appl. No.: 10/641,256

(22) Filed: Aug. 13, 2003

(30) Foreign Application Priority Data
Jan. 14, 2003 (KR) 2003-2465

(51) Int. Cl. H04N 5/225

(52) U.S. Cl. 348/340

(57) ABSTRACT

Disclosed is a camera module and method of fabricating the same. The camera module in which an image sensor and an image signal processor are mounted on any one side of a substrate, comprises the substrate on which a copper layer is formed, and a bonding pad part formed on the copper layer and including a gold-plated layer with a same thickness. A print solder resister layer is formed around the bonding pad part and removed by an area corresponding to the bonding pad part on which the image signal processor is mounted. The image sensor and the image signal processor are bonded to the bonding pad part. The camera module and method of fabricating the camera module is advantageous in that a wire-bonding and a bump-bonding process requiring different plating conditions in forming a gold-plated layer on a single substrate are simultaneously applied to the single substrate, components such as an image sensor and an image signal processor are mounted on an upper side or an upper and a lower side of the single substrate while being minimized in their height, and a total mounting area of the components on the substrate is minimized, thereby greatly slimming the camera module.

### BACKGROUND OF THE INVENTION

1. Field of the Invention

The present invention pertains, in general, to a camera module and method of fabricating the same and, in particular, to a camera module whose image sensor and image signal processor (ISP) have a maximally reduced height by using a wire- and a bump-bonding process, and a method of fabricating the same.

2. Description of the Prior Art

As well known to those skilled in the art, a mobile telephone provided with a camera is increasingly being used in accordance with the recent trend of using the mobile telephone as an information terminal. In this regard, there is needed an optical camera module, for use in the mobile telephone, which is much smaller than that of a digital camera or a camera for PC.

If the camera module is thicker than 5 to 7 mm, it is impossible to apply it to the recent mobile telephones. Furthermore, in progress of time, it is expected to use mega-sized or larger effective-pixels in the camera for the mobile telephone, so the camera module will be undesirably bulky. Therefore, various efforts have been made to reduce a size of the camera module including a lens.

Examples of methods of downsizing the camera module include use of a CCD image sensor (charge coupled device image sensor) or CMOS image sensor (complementary metal oxide semiconductor image sensor), downsizing of the lens, reduction of an interval between pixels of the image sensor, and improvement in a packaging technology of the camera module.

Meanwhile, a conventional method of fabricating the camera module using a surface mounting technology (SMT) comprises the steps of mounting image sensors (image pickup device), ISPs, and passive parts such as condensers on a patterned substrate, covering the resulting substrate with the use of a housing provided with a filter, and combining a lens with the resulting structure.

Describing the above mounting step in detail, the image sensor firstly packaged by a ceramic leadless chip carrier (CLCC) process using ceramics is secondly packaged by a quad flat pack (QFP) or ball grid array (BGA) process to form an image sensor package 1a, the image sensor package 1a thus formed is mounted in conjunction with the passive parts 2a on the substrate 3a using a surface mounting technology, and an ISP package 4a is wire-bonded to a lower side of the substrate 3a, as shown in FIG. 1.

This conventional method using the surface mounting technology is easy to conduct, but is disadvantageous in that the whole camera module is bulky because the image sensor and ISP are mounted on the substrate while being separately packaged, so it is commercially disadvantageous to apply the camera module to the mobile telephone.

With reference to FIG. 2, there is illustrated a camera module fabricated by another conventional method using a wire-bonding process. The conventional method comprises the steps of wire-bonding the image sensor 1b and passive parts 2b to an upper side of the substrate 3b, wire-bonding an ISP 4b to a lower side of the substrate 3b, and encapsulating the ISP 4b wire-bonded to the lower side of the substrate 3b. At this time, the image sensor 1b consists of a bare chip without being packaged in a chip-on-board (COB) manner.

The conventional method using the wire-bonding process reduces a thickness of the camera module slightly more than the conventional method using the surface mounting technology, but has disadvantages in that the camera module is hard to commercially apply to the mobile telephone because the encapsulated ISP is thick.

To avoid the above disadvantages, a method of fabricating the camera module using a bump-bonding process as well as the wire-bonding process may be suggested, in which the image sensor is wire-bonded to the substrate and the ISP is bump-bonded to the substrate to mount the image sensor and ISP on the substrate in a form of chip-sized package, thereby reducing the thickness of the camera module.

At this time, a gold-plated layer is formed on the substrate under the same conditions as the conventional methods using the surface mounting or wire-bonding process.

However, when the wire-bonding and bump-bonding process are simultaneously applied to the gold-plated layer on the substrate, two portions of the gold-plated layer to which each process is applied are different from each other in terms of thickness, so electrical reliability of the camera module is not ensured. Therefore, it is impossible to simultaneously apply the wire-bonding and bump-bonding process to the single substrate because electrical connection between the sensor and the substrate is not sufficiently reliable.

Further, in the method simultaneously using the wire-bonding and bump-bonding process, it is preferable that the thickness of the gold-plated layer formed on the substrate is 0.5 μm or thicker on average when the wire-bonding process is needed, so that damage to the substrate occurring upon wire-bonding wires to the substrate is prevented and pads on the substrate are firmly combined with the wires.

Furthermore, if the gold-plated layer on bump-bonding pads of the substrate is thick, an alloy is formed at an interface between the bump-bonding pads and the gold-plated layer due to a chemical reaction between the bump-bonding pads consisting of lead (Pb) and the gold-plated layer after a bump-bonding process is finished to cause a cracking at the interface, thus bringing about noise at the interface and reducing electrical reliability of the camera module. Therefore, it is necessary to thinly plate gold on the substrate during the bump bonding process. At this time, the gold-plated layer functions to prevent a copper plate of the substrate from oxidizing.

An attempt has been made to avoid the disadvantages occurring in the method simultaneously using the wire-bonding and bump-bonding process. The attempt comprises the steps of thinly plating the whole upper side of the substrate with gold so as to be suitable to the bump bonding process, attaching a protective tape on an area other than a portion of the substrate onto which the image sensor is wire-bonded, thickly plating the upper side of the resulting substrate with gold, and detaching the protective tape from the resulting structure to form the gold-plated layer with a height suitable for the wire-bonding and bump-bonding process.

However, this attempt is insufficiently competitive in terms of fabrication time and cost of the camera module because the fabrication process is complex, that is to say, the plating step is conducted two times and the protective tape is cumbersomely attached and detached, and it is not estimated to sufficiently ensure electrical reliability of the camera module.

Accordingly, there remains a need to desirably control the thickness of the gold-plated layer so as to simultaneously apply the wire-bonding and bump-bonding process to the single substrate.

The present inventors have conducted extensive studies directed toward slimming of the camera module, resulting in the finding that after a print solder resister (PSR) layer is completely removed from the bump-bonding pads so as to prevent cracking at the interface between the bump-bonding pads and the gold-plated layer and to ensure electrical reliability of the camera module, gold is uniformly plated on the regions of wire-bonding pads and bump-bonding pads in the upper of the substrate with a same thickness and in minimum allowable thickness capable of securing electrical reliability of the camera module in the case of using the wire-bonding process, electrical reliability of the camera module using the wire- and bump-bonding process is secured even though the gold plating process is conducted one time. Through the above technique, furthermore, it was found that a loop height (a distance between a top of a chip wire-bonded to the substrate and a maximum height of the wire bonded to the substrate) is reduced by flip-chip-bump bonding the ISP to the substrate to mount the image sensor and ISP on the single substrate to maximally slim the camera module, thereby reducing an area of the substrate occupied by the ISP using a rearrangement process before the ISP is bump-bonded to the substrate and connecting overlapped pads to each other to reduce the size of a final I/O pad.

### SUMMARY OF THE INVENTION

Therefore, the present invention has been made keeping in mind the above disadvantages occurring in the prior arts, and an object of the present invention is to provide a camera module in which components such as an image sensor and an image signal processor are mounted on a substrate while being minimized in their height, and a method of fabricating the camera module.

It is another object of the present invention to provide a camera module in which components such as an image sensor and an image signal processor are mounted on an upper and a lower side of a substrate while being minimized in their height, and their mounting area on the upper and lower side of the substrate is minimized, and a method of fabricating the camera module.

It is still another object of the present invention to provide a method of fabricating a camera module, in which a wire-bonding and a bump-bonding process requiring different plating conditions in forming a gold-plated layer on a single substrate are simultaneously applied to any one side of the single substrate.

Based on the present invention, the above objects can be accomplished by providing a camera module according to a first embodiment of a first aspect of the present invention. The camera module in which an image sensor and an image signal processor are mounted on any one side of a substrate, comprises the substrate on which a copper layer is formed, and a bonding pad part formed on the copper layer and including a gold-plated layer with a same thickness. A print solder resister layer is formed around the bonding pad part and removed by an area corresponding to the bonding pad part on which the image signal processor is mounted. Additionally, the image sensor and the image signal processor are bonded to the bonding pad part.

At this time, the gold-plated layer is 0.2 to 0.3 μm in thickness, and the image signal processor is previously rearranged before being bump-bonded to the bonding pad part.

Further, the image signal processor is underfilled with packing materials, and the substrate is a copper clad laminate.

Furthermore, the image sensor is wire-bonded to the bonding pad part and the image signal processor is flip-chip bonded to the bonding pad part.

The bonding pad part may further comprise a nickel-plated layer.

According to a first embodiment of a second aspect of the present invention, there is provided a method of fabricating a camera module comprising coating an etch-film and a first exposure-film on a copper layer of a substrate and exposing the first exposure-film to ultraviolet rays to develop a resulting substrate, and etching the resulting copper layer and etch-film to form a circuit pattern, wire-bonding and bump-bonding pads. The method also includes constructing a print solder resister layer for protecting the circuit pattern, coating a second exposure-film on the print solder resister layer and exposing the second exposure-film to the ultraviolet rays to develop the wire-bonding and bump-bonding pads to completely remove a portion of the print solder resister layer corresponding to a bump-bonding pad area, forming a nickel-plated layer on the wire-bonding and bump-bonding pads, forming a gold-plated layer on the nickel-plated layer, wire-bonding an image sensor to the wire-bonding pads, bump-bonding a rearranged image signal processor to the bump-bonding pads, and underfilling the image signal processor bump-bonded to the bump-bonding pads with the use of packing materials.

At this time, the gold-plated layer is 0.2 to 0.3 μm in thickness.

Furthermore, the substrate is a copper clad laminate.

According to a second embodiment of the first aspect of the present invention, there is provided a camera module in which an image sensor and an image signal processor are respectively mounted on different sides of a substrate. The camera module comprises the substrate on which a copper layer is formed, and a bonding pad part formed on the copper layer and including a gold-plated layer with a same thickness as the copper layer. A print solder resister layer is formed around the bonding pad part on an upper side of the substrate, and the image sensor is bonded to the bonding pad part on the upper side of the substrate. Further, the image signal processor is bonded to the bonding pad part on a lower side of the substrate. A flexible printed circuit board is bonded to the bonding pad part around the image signal processor to be electrically connected to the bonding pad part.

In this regard, the gold-plated layer is 0.2 to 0.3 μm in thickness, and the image signal processor is previously rearranged before being bonded to the bonding pad part.

Moreover, the image signal processor is underfilled with packing materials.

Furthermore, the substrate is a copper clad laminate.

The image sensor is wire-bonded to the bonding pad part, and the image signal processor is flip-chip bonded to the bonding pad part.

As well, the bonding pad part further comprises a nickel-plated layer.

Additionally, it is preferable that the image signal processor is encapsulated.

According to a second embodiment of the second aspect of the present invention, there is provided a method of fabricating a camera module comprising coating etch-films and first exposure-films on copper layers on an upper and a lower side of a substrate and exposing the first exposure-films to ultraviolet rays to develop a resulting substrate, and etching the resulting copper layers and etch-films to form a first circuit pattern and wire-bonding pads on the upper side of the substrate and a second circuit pattern and bump-bonding pads on the lower side of the substrate. The method also includes constructing a print solder resister layer for protecting the first circuit pattern on the upper side of the substrate, respectively forming a nickel-plated layer and a gold-plated layer on the wire-bonding pads and the bump-bonding pads, bump-bonding a rearranged image signal processor to the bump-bonding pads, encapsulating the image signal processor bump-bonded to the bump-bonding pads, and wire-bonding an image sensor to the wire-bonding pads.

The substrate is a copper clad laminate, and the gold-plated layer is 0.2 to 0.3 μm in thickness.

The method may further comprises electrically connecting a flexible printed circuit board to the substrate. At this time, the flexible printed circuit board is positioned close to the image signal processor.

### BRIEF DESCRIPTION OF THE DRAWINGS

The above and other objects, features and other advantages of the present invention will be more clearly understood from the following detailed description taken in conjunction with the accompanying drawings, in which:

FIG. 1 schematically illustrates a camera module fabricated using a conventional surface mounting technology;

FIG. 2 schematically illustrates a camera module fabricated using a conventional chip-on-board technology;

FIGS. 3 and 4 schematically illustrate a camera module according to a first embodiment of a first aspect of the present invention;

FIG. 5 schematically illustrates a camera module according to a second embodiment of the first aspect of the present invention;

FIGS. 6 to 13 schematically illustrate the fabrication procedure of the camera module according to a first embodiment of a second aspect of the present invention; and

FIGS. 14 to 18 schematically illustrate the fabrication procedure of the camera module according to a second embodiment of the second aspect of the present invention.

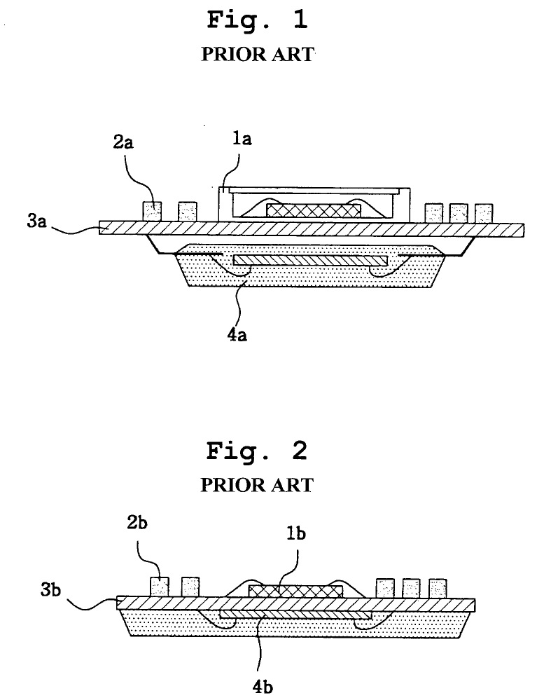

### DETAILED DESCRIPTION OF THE INVENTION

Now, preferred embodiments of a camera module of the present invention will be described below with reference to the accompanying drawings.

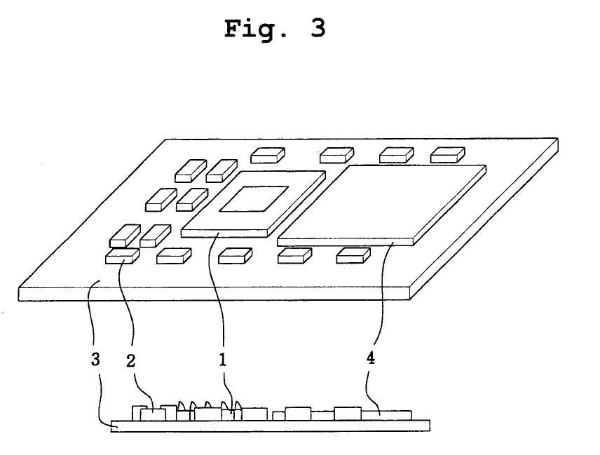

According to a first embodiment of a first aspect of the present invention, an image sensor 1, an ISP 4, and passive parts 2 such as condensers are mounted on an upper side of a substrate 3 as shown in FIG. 3.

At this time, the substrate 3 includes a circuit pattern and bonding pads constructed thereon, and nickel and gold are plated on the circuit pattern and bonding pads. There is frequently used as the substrate 3 a copper clad laminate (CCL) in which a copper layer is thinly plated on any one side or both sides of the single substrate, but in the present invention, the substrate whose upper side is plated with copper is used. A more detailed description of the substrate will be given later.

The image sensor 1 is positioned in the vicinity of the ISP 4 on the substrate 3, and the passive parts 2 are placed around them.

The image sensor 1 is wire-bonded onto a gold-plated layer on wire-bonding pads. Illustrating, but non-limiting examples of the image sensor 1 include CCD- or CMOS-type image sensors.

Additionally, a thickness of the gold-plated layer on the wire-bonding pads depends on a minimum thickness capable of ensuring electrical reliability of a wire bonder of the associated image sensor. It is experimentally confirmed that the minimum thickness of the gold-plated layer on the wire-bonding pads should range from 0.2 to 0.3 μm so as to secure electrical reliability of the wire bonder.

As well, a PSR layer is formed on a portion on which the image sensor 1 is mounted. In detail, the PSR layer is formed on whole upper side of the substrate 3 except for a wire-bonding pad area of the image sensor 1. As widely known in the art, the PSR layer acts as a protective layer for electrically protecting a circuit pattern of the image sensor.

The ISP 4 is close to the image sensor 1 on the substrate, and bump-bonded to the gold-plated layer on bump-bonding pads.

The bump-bonding pads consist of the gold-plated layer having the same thickness as the wire-bonding pads for the image sensor. As described above, the gold-plated layer is preferably 0.2 to 0.3 μm in thickness, and a portion of the PSR layer having a size as large as the ISP chip is removed so as to enlarge a contact surface between a bump and the bump-bonding pads and secure electrical reliability of the camera module. This is a critical characteristic of the present invention different from the conventional methods, and the PSR layer is not formed on a bump-bonding pad area.

Further, the ISP 4 is treated according to a rearrangement process in a wafer level before being bump-bonded onto the substrate, thereby reducing a mounting area of the ISP on the substrate in comparison with a conventional wire-bonding process.

Furthermore, the ISP 4 is underfilled with packing materials so as to secure electrical reliability of the camera module.

Meanwhile, as described above, the passive parts 2 such as condensers and resistors are properly located around the image sensor 1 and ISP 4.

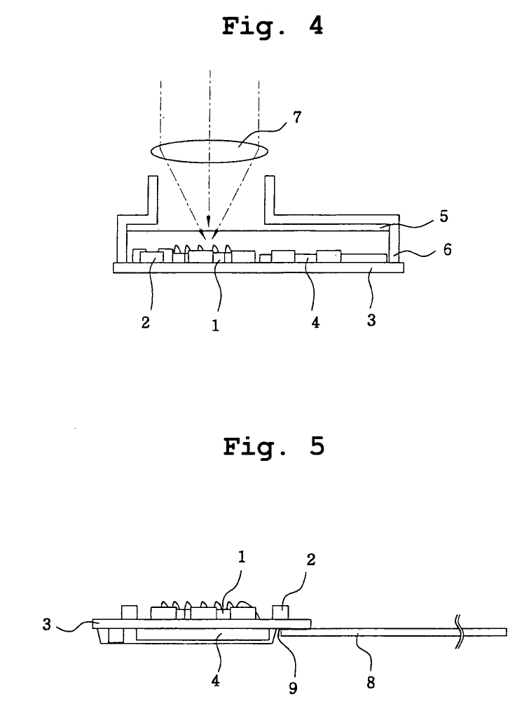

With reference to FIG. 4, the substrate 3 on which the image sensor 1, the passive parts 2, and the ISP 4 are mounted is put into a housing 6 with a filter 5, and a lens 7 is then combined with the resulting housing 6, thereby accomplishing the camera module.

This camera module is fabricated in such a way that a portion of the PSR layer corresponding to the bonding pad area on which the ISP is mounted is completely removed, thus being slimmed in comparison with conventional camera modules.

To sum up, the camera module according to the first embodiment of the first aspect of the present invention is structured such that the image sensor and the ISP are respectively wire-bonded and bump-bonded to the wire and bump bonding pads including the gold-plated layer capable of securing electrical reliability of the wire bonder of the image sensor, thereby slimming the camera module.

Hereinafter, there will be given a detailed description of a camera module according to a second embodiment of the first aspect of the present invention.

Unlike the camera module according to the first embodiment of the first aspect in which only a height of the camera module is reduced, the camera module according to the second embodiment of the first aspect of the present invention is reduced in terms of thickness and area.

According to the second embodiment of the first aspect, an image sensor 1 is wire-bonded to an upper side of a substrate 3 as shown in FIG. 5. Further, passive parts 2 such as condensers and resistors are located around the image sensor 1 like the first embodiment of the first aspect.

In detail, the image sensor 1 is wire-bonded to a gold-plated layer on wire-bonding pads on the substrate. Additionally, a thickness of the gold-plated layer on the wire-bonding pads depends on a minimum thickness capable of ensuring electrical reliability of a wire bonder of the associated image sensor. As described above, the minimum thickness of the gold-plated layer on the wire-bonding pads preferably ranges from 0.2 to 0.3 μm. Furthermore, the PSR layer is formed on the substrate 3 on which the image sensor 1 is mounted in such a way that the wire-bonding pads are opened.

However, in accordance with the second embodiment of the first aspect, the ISP 4 is encapsulated after being bump-bonded to a lower side of the substrate 3, unlike the case of the first embodiment of the first aspect. For this reason, the bump-bonding pads are formed without the PSR layer in the same size as the ISP chip on the lower side of the substrate 3, and the ISP 4 is subjected to a rearrangement process before being bump-bonded to the bump-bonding pads to minimize an area occupied by the ISP 4 on the substrate 3. In comparison with the conventional method (FIG. 2), the height of the camera module according to the second embodiment of the first aspect of the present invention is desirably reduced because a size of the encapsulated ISP bonded to the lower side of the substrate 3 is reduced by wire-loops.

As well, a bonding area 9 for connecting applications such as mobile telephones adopting the camera module of the present invention to a flexible PCB 8 is bonded to the lower side of the substrate 3, and the ISP is encapsulated while the flexible PCB bonding area 9 is not encapsulated.

As described above, the camera module according to the second embodiment of the first aspect of the present invention is structured such that the image sensor 1 is wire-bonded to the upper side of the substrate 3, the ISP 4 is bump-bonded to the lower side of the substrate 3 and then encapsulated, thereby reducing the thickness and area of the camera module. At this time, the area of the camera module is reduced by a total area of the ISP mounted on the substrate 3.

Now, there will be described a method of fabricating the camera module according to a first embodiment of a second aspect of the present invention.

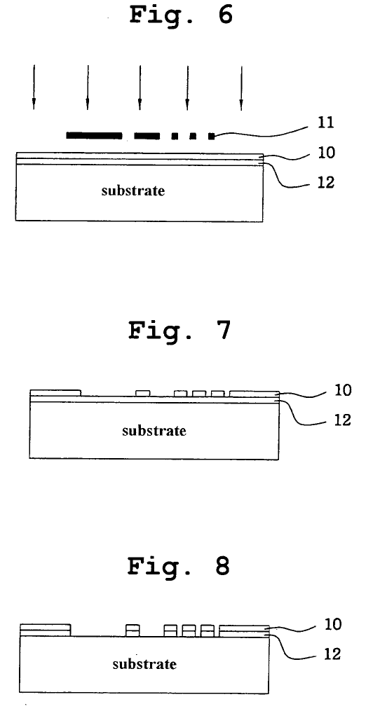

Referring to FIG. 6, an etch-film 10 and an exposure-film 11 are coated on a substrate, and the resulting substrate is exposed by ultraviolet rays. As described above, the substrate is preferably the CCL in which a copper layer is thinly plated on any one side or both sides of the substrate and, in the first embodiment of the second aspect of the present invention, the CCL whose upper side is plated with copper.

As in FIG. 7, if the etch-film 10 exposed to the ultraviolet rays is developed by a developing liquid, a portion of the etch-film 10 in which a circuit pattern and bonding pads are to be formed remains on a copper layer 12 of the substrate.

The copper layer 12 is then etched as shown in FIG. 8. At this time, a portion of the copper layer 12 in which the circuit pattern and bonding pads are to be formed is not etched by the etch-film 10. Examples of processes of etching the copper layer 12 may include a metal etching process and a photo-etching process which are conventionally used to etch the copper layer.

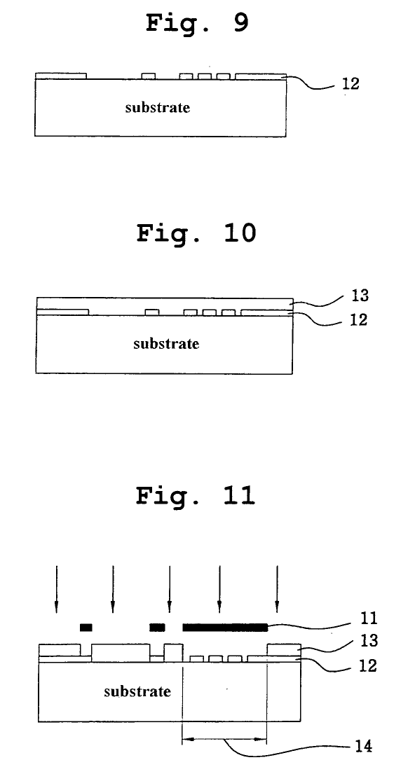

With reference to FIG. 9, after the etch-film 10 remaining on the copper layer is etched, the circuit pattern, the wire- and bump-bonding pads consisting of the copper layer 12 are formed on the substrate.

Furthermore, a PSR layer 13 is formed on the circuit pattern so as to protect the circuit pattern, as shown in FIG. 10.

The exposure-film 11 is coated on the PSR layer 13 and exposed to ultraviolet rays so that the PSR layer is completely removed by a portion corresponding to the bump-bonding pad area 14 on which the ISP is mounted, as shown in FIG. 11. The wire- and bump-bonding pads are then developed by a developing liquid. Thereby, it is easy to horizontally maintain the ISP during the bump bonding process, forces applied to the ISP are uniform, and a contact area between the bump and the substrate pad is broadened to ensure bonding-reliability of the pad to the substrate to secure electric stability of the pad.

A nickel-plated layer 15 and a gold-plated layer 16 are then formed on the wire- and bump-bonding pads consisting of the copper layer 12 as shown in FIG. 12. The nickel-plated layer 15 acts as a protective layer for preventing the gold-plated layer 16 and the copper layer 12 from being mixed with each other and securing hardness of the gold- and copper-plated substrate.

As for the thickness of the gold-plated layer 16, it is preferably within a range of 0.2 to 0.3 μm. The thickness corresponds to the minimum thickness of the gold-plated layer capable of ensuring electrical reliability of the wire bonder of the associated image sensor, and also corresponds to the optimum thickness range of the gold-plated layer in the case of simultaneously applying the wire- and bump-bonding process to the single substrate.

For example, when the gold-plated layer 16 is thinner than the range of 0.2 to 0.3 μm, the pads are easily damaged due to a shock occurring in attaching of the wire bonder to the wire and an attaching force between the wire and the pads are weak, so it is difficult to secure electrical reliability between the pad and the wire.

On the other hand, when the gold-plated layer 16 is thicker than the range, an alloy is formed at an interface between the bump-bonding pads and the gold-plated layer due to a chemical reaction between the bump-bonding pads consisting of lead (Pb) and the gold-plated layer after a bump-bonding process is finished to cause a cracking at the interface, thus bringing about noise at the interface and reducing electrical reliability of the camera module, and reducing the bonding reliability between the bump-bonding pads and the gold-plated layer due to difficulty in maintaining the horizon of the ISP during the bump-bonding process and difference in heights of the bumps.

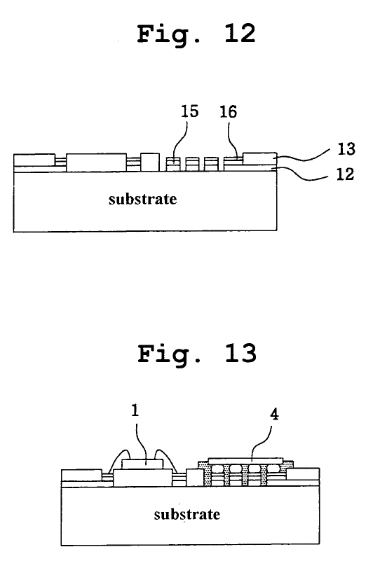

The image sensor 1 is then wire-bonded to the wire-bonding pad, the ISP 4 is bump-bonded to the bump-bonding pad, and the ISP 4 is underfilled with packing materials, as shown in FIG. 13.

Therefore, the image sensor 1 and the ISP 4 are mounted on the bonding pads of the substrate 3, the passive parts 2 such as condensers and resistors are properly located around the image sensor 1 and ISP 4, the substrate 3 on which the image sensor 1, the passive parts 2, and the ISP 4 are mounted is put into a housing 6 with a filter 5, and a lens 7 is then combined with the resulting housing 6, thereby accomplishing the camera module.

A detailed description will be given of a method of fabricating a camera module according to a second embodiment of the second aspect of the present invention, below.

According to the second embodiment of the second aspect of the present invention, the CCL in which an upper and a lower side are both plated with copper is used as a substrate.

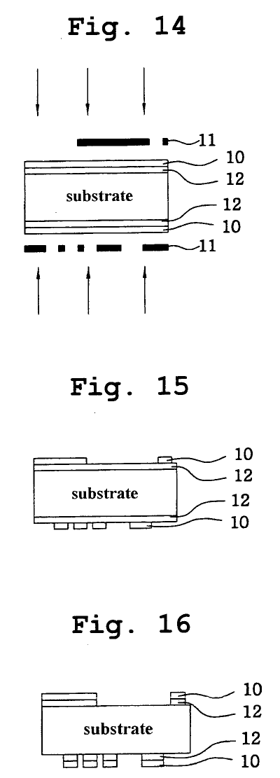

Referring to FIG. 14, an etch-film 10 and an exposure-film 12 are coated on a copper layer 12, and the resulting copper layer is exposed by the ultraviolet rays. At this time, a first pattern for an image sensor and passive parts is formed on the exposure-film 12 coated on the upper side of the substrate, and a second pattern for an ISP is formed on the exposure-film 12 coated on the lower side of the substrate.

As in FIG. 15, if the etch-film 10 exposed to the ultraviolet rays is developed by a developing liquid, a portion of the etch-film 10 in which a circuit pattern and bonding pads are to be formed remains on the copper layers 12 of an upper and a lower side of the substrate.

The copper layers 12 are then etched as shown in FIG. 16. At this time, a portion of the copper layers 12 in which the circuit pattern and bonding pads are to be formed is not etched by the etch-films 10. Examples of processes of etching the copper layers 12 may include a metal etching process and a photo-etching process which are conventionally used to etch the copper layer.

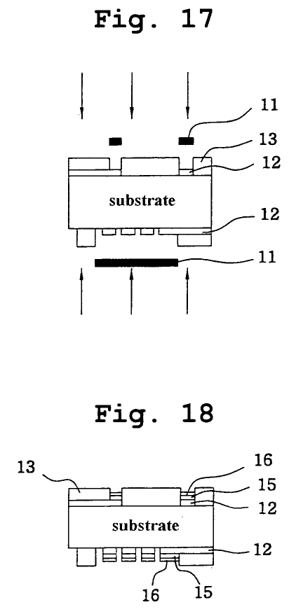

With reference to FIG. 17, after the etch-films 10 remaining on the copper layers are etched, the circuit pattern and wire-bonding pads consisting of the copper layer 12 are formed on the upper side of the substrate, and the circuit pattern and bump-bonding pads consisting of the copper layer 12 are formed on the lower side of the substrate. Additionally, a PSR layer 13 for protecting the circuit pattern is further formed on the upper side of the substrate.

A nickel-plated layer 15 and a gold-plated layer 16 are then formed on the wire- and bump-bonding pads consisting of the copper layer 12, respectively. At this time, the gold-plated layer 16 is preferably 0.2 to 0.3 μm in thickness.

The ISP 4 is bump-bonded to the bump-bonding pads on the lower side of the substrate, underfilled with packing materials, and encapsulated in conjunction with some of passive parts. In addition, remaining passive parts are mounted on the upper side of the substrate and the image sensor 1 is wire-bonded to the wire-bonding pad, thereby accomplishing the camera module of FIG. 5.

As described above, it is preferable that a flexible PCB bonding area 9 on the lower side of the substrate is not encapsulated when the ISP 4 is encapsulated, the encapsulated substrate is put into a housing with a filter, and a lens 7 is then combined with the resulting housing, thereby accomplishing the camera module.

Therefore, the present invention is advantageous in that an image sensor and an ISP are respectively wire-bonded and bump-bonded to a single substrate in such a way that a thickness of a gold-plated layer of each bonding pad corresponds to a minimum thickness capable of ensuring electrical reliability of a wire bonder of the image sensor and a portion of a PSR layer as large as a size of an ISP chip in a bump-bonding pad area is removed, thereby simultaneously applying a wire- and a bump-bonding process to the single substrate.

Other advantages are that the thickness of the image sensor and ISP are minimized and the ISP is bump-bonded to the substrate after being previously rearranged, thus minimizing an area of the substrate occupied by the ISP mounted on the substrate and slimming the camera module.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

What is claimed is:

1. A camera module in which an image sensor and an image signal processor are mounted on any one side of a substrate, comprising:
the substrate on which a copper layer is formed;
a bonding pad part formed on the copper layer and including a gold-plated layer with a same thickness;
a print solder resister layer formed around the bonding pad part and removed by an area corresponding to the bonding pad part on which the image signal processor is mounted; and
the image sensor and the image signal processor bonded to the bonding pad part.

2. The camera module as set forth in claim 1, wherein the gold-plated layer is 0.2 to 0.3 μm in thickness.

3. The camera module as set forth in claim 1, wherein the image signal processor is previously rearranged before being bump-bonded to the bonding pad part.

4. The camera module as set forth in claim 1, wherein the image signal processor is underfilled with packing materials.

5. The camera module as set forth in claim 1, wherein the substrate is a copper clad laminate.

6. The camera module as set forth in claim 1, wherein the image sensor is wire-bonded to the bonding pad part and the image signal processor is flip-chip bonded to the bonding pad part.

7. The camera module as set forth in claim 1, wherein the bonding pad part further comprises a nickel-plated layer.

8. A method of fabricating a camera module, comprising:
coating an etch-film and a first exposure-film on a copper layer of a substrate and exposing the first exposure-film to ultraviolet rays to develop a resulting substrate;
etching the resulting copper layer and etch-film to form a circuit pattern, wire-bonding and bump-bonding pads;
constructing a print solder resister layer for protecting the circuit pattern;
coating a second exposure-film on the print solder resister layer and exposing the second exposure-film to the ultraviolet rays to develop the wire-bonding and bump-bonding pads to completely remove a portion of the print solder resister layer corresponding to a bump-bonding pad area;
forming a nickel-plated layer on the wire-bonding and bump-bonding pads;
forming a gold-plated layer on the nickel-plated layer;
wire-bonding an image sensor to the wire-bonding pads;
bump-bonding a rearranged image signal processor to the bump-bonding pads; and
underfilling the image signal processor bump-bonded to the bump-bonding pads with the use of packing materials.

9. The method as set forth in claim 8, wherein the gold-plated layer is 0.2 to 0.3 μm in thickness.

10. The method as set forth in claim 8, wherein the substrate is a copper clad laminate.

11. A camera module in which an image sensor and an image signal processor are respectively mounted on different sides of a substrate, comprising:
the substrate on which a copper layer is formed;
a bonding pad part formed on the copper layer and including a gold-plated layer with a same thickness as the copper layer;
a print solder resister layer formed around the bonding pad part on an upper side of the substrate;
the image sensor bonded to the bonding pad part on the upper side of the substrate;
the image signal processor bonded to the bonding pad part on a lower side of the substrate; and
a flexible printed circuit board bonded to the bonding pad part around the image signal processor to be electrically connected to the bonding pad part.

12. The camera module as set forth in claim 11, wherein the gold-plated layer is 0.2 to 0.3 μm in thickness.

13. The camera module as set forth in claim 11, wherein the image signal processor is previously rearranged before being bonded to the bonding pad part.

14. The camera module as set forth in claim 11, wherein the image signal processor is underfilled with packing materials.

15. The camera module as set forth in claim 11, wherein the substrate is a copper clad laminate.

16. The camera module as set forth in claim 11, wherein the image sensor is wire-bonded to the bonding pad part and the image signal processor is flip-chip bonded to the bonding pad part.

17. The camera module as set forth in claim 11, wherein the bonding pad part further comprises a nickel-plated layer.

18. The camera module as set forth in claim 11, wherein the image signal processor is encapsulated.

19. A method of fabricating a camera module, comprising:
coating etch-films and first exposure-films on copper layers on an upper and a lower side of a substrate and exposing the first exposure-films to ultraviolet rays to develop a resulting substrate;
etching the resulting copper layers and etch-films to form a first circuit pattern and wire-bonding pads on the upper side of the substrate, and a second circuit pattern and bump-bonding pads on the lower side of the substrate;
constructing a print solder resister layer for protecting the first circuit pattern on the upper side of the substrate;
forming a nickel-plated layer and a gold-plated layer on the wire-bonding pads and the bump-bonding pads, respectively;
bump-bonding a rearranged image signal processor to the bump-bonding pads;
encapsulating the image signal processor bump-bonded to the bump-bonding pads; and
wire-bonding an image sensor to the wire-bonding pads.

20. The method as set forth in claim 19, wherein the substrate is a copper clad laminate.

21. The method as set forth in claim 19, wherein the gold-plated layer is 0.2 to 0.3 μm in thickness.

22. The method as set forth in claim 19, further comprising electrically connecting a flexible printed circuit board to the substrate, said flexible printed circuit board being positioned close to the image signal processor.
